(19) United States
(12) Patent Application Publication
(10) Pub. No.: US 2020/0112150 A1
(43) Pub. Date: Apr. 9, 2020

(54) Wire Hook

(71) Applicant: Catalin Virgil Captarencu, Lake Zurich, IL (US)

(72) Inventor: Catalin Virgil Captarencu, Lake Zurich, IL (US)

(21) Appl. No.: 16/152,001

(22) Filed: Oct. 4, 2018

(51) Int. Cl. H02G 1/08

(52) U.S. Cl. CPC H02G 1/088

(57) ABSTRACT

A wire hook having a body portion adapted to connect to a fish rod set comprising two opposed hook members configured to engage a wire or rod in an open position and secure said wire or rod in a locked position such that the wire or rod may be lifted and pulled once from the other end of the fish rod.

### FIELD OF THE INVENTION

The present disclosure relates to a fish rod hooks, and more particularly to specialized hooks for pulling and retrieving wires.

### BACKGROUND OF THE INVENTION

In the construction field, when remodeling of existing structures, electricians typically are required to install new wires or to retrofit existing wires through and behind the previously built walls, floors, and ceilings of buildings. The use of fiberglass poles, commonly called fish rods or fish sticks, to pull wires and cables through such inaccessible areas of a structure is widely known. A typical fish rod consists of long thin material, usually fiberglass, rigid enough to push through and past obstructions, let flexible enough to bend around some of these same obstacles. Fish rods are typically terminated with either a permanently installed engagement member, such as a hook or eyelet, or with a threaded member to which an engagement member or an additional length of fish rod may be affixed. Commonly engagement members in the prior art consist of standard J-shaped hooks, bullet noses, and wire cages, among others.

The common J-shaped hook is also convenient for hooking onto and retrieving objects which may be inaccessible behind the walls of a structure, but generally has the weakness that it are likely to snag upon retrieval because the open portion of the hook protrudes outward from the axis of the fish rod. Because the J-hook is open on one side, it is also highly likely that a pulled wire will slip out of the grasp of the J-hook if it encounters an obstacle. It would therefore be advantageous to retain the wire-retrieving benefits of the J-hook while eliminating the tendency of the J-hook to snag on corners and other surfaces and to drop wires.

Another common engagement member for fish rods is commonly referred to as a “bullet nose.” A bullet nose engagement member is a rounded, low-profile termination of a fish rod, usually not much larger in diameter than the fish rod itself, with a hole in the nose to allow for wires and cables to be tied to the bullet nose, either directly or through the use of wire mesh grips common in the prior art. The bullet nose tends to be easy to feed into a work area and retrieve from, but lacks the ability to grab or retrieve any objects that may have been dropped in the work area. It would therefore be advantageous to retain the rounded low profile of the bullet nose for ease of insertion and recovery and still allow for objects to be retrieved.

A third common engagement member for a fish tape is a “wire cage.” A wire cage engagement member is a high profile ball-shaped cage of rigid metal attached to the end of a fish rod. As with the bullet nose engagement member, wires and cables may be tied to a wire cage and pulled through the work area. The large, rounded profile of the wire cage is helpful for pushing aside any existing wires or other obstacles, clearing the way for the pulled wires, but the wire cage is not able to pick up or retrieve any wires in the work area and is too bulky to use in many crowded areas. It would therefore be advantageous to retain the area-clearing benefits of the wire cage while and still allow for the retrieval and maneuvering of items at the end of the fish tape.

The present invention solves all of these problems and allows a user to perform all of the tasks normally performed by the bullet nose, the J-hook, and the wire cage with one simple device.

### SUMMARY OF THE INVENTION

In an example embodiment of the present invention, an improved wire pulling hook is disclosed. The improved wire hook for use with fish rods overcomes the above-mentioned limitations of the fish rod hooks now present in the prior art. The purpose of the present invention is to provide all of the advantages of the prior art hooks, including retrieval of dropped or inaccessible wires, low-profile pulling of wires, and clearance of obstacles, while reducing the tendency of such systems to drop wires or snag on protruding surfaces.

To accomplish this purpose, this example embodiment of the present invention consists of a pair of S-shaped hooks in lieu of the single J-hook, wire cage, or bullet nose, the S-shaped hooks attached to a post in an opposite and nearly parallel configuration. The lower portion of each of the hooks presents a profile similar to that of a J-hook attachment member to a wire to be retrieved and the upper portion of the hooks presents a profile similar to that of a wire cage to clear obstacles.

Retrieval of wires is accomplished by positioning each of the two S-shaped hooks on either side of a wire to be retrieved, such that the wire is located between the two hooks. By twisting the rod in a particular direction, the S-shaped hooks are rotated to entrap the wire within both of the two hooks. When in this locked configuration, the wire cannot fall out of the hooks because each opposed hook member effectively closes the gap of the opposing hook. The hook is unlikely to snag because the upper portions of the hooks shield the open lower portions of the hooks and clear obstacles away from a potential snag.

This summary is expository only and is not intended to be in any way limiting of the invention. In addition to the illustrative aspects, features, and properties of the embodiment above, additional aspects, features, and properties will become apparent by reference to the drawings and the following detailed description.

### BRIEF DESCRIPTION OF THE DRAWINGS

FIG. 1 is a perspective view of a typical fish rod hook present in the prior art.

FIG. 2 is a perspective view of a device which is a representative embodiment of the present invention.

FIG. 3 is a perspective view of the device of FIG. 2 engaging a wire its open position.

FIG. 4 is a perspective view of the device in FIG. 2 engaging a wire in its locked position.

FIG. 5 is a side view of the device in FIG. 2.

FIG. 6 is a perspective view of a devices which is a representative embodiment of the present invention.

### DETAILED DESCRIPTION

In this description, references are made to the drawings which are part of the description. In the drawings, similar symbols identify similar parts, unless noted otherwise. The embodiment described in the detailed description, drawings, and claims is not intended to be limiting. Other embodiments may be used, and other changes may be made within the scope of the subject matter of this description. It will be apparent that the aspects of this disclosure can be arranged, substituted, combined, separated, and designed in multiple configurations, all of which are contemplated in this description.

In structures which have multiple stories, wires and cables are commonly installed vertically across multiple floors. The method commonly used is “fishing,” employing a long thin “fish rod” of fiberglass or other material to enter the wall at a desired location, pushing it through an opening in the floor or ceiling, and retrieving the rod on the other side. The present application is directed to a method and system for terminating such a fish rod to allow it to be used to pull, retrieve, and route wires in an installation or other similar application.

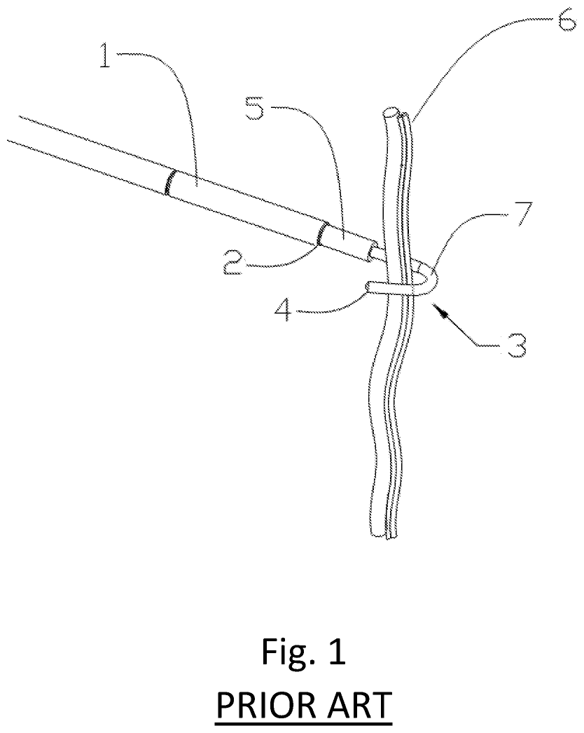

FIG. 1 depicts a fish rod 1 with a threaded tip 2 and a J-type hook attachment 3, as commonly practiced in the prior art. The J-type hook attachment 3 features a hook portion 4, a bend portion 7, a body portion 5, and a threaded post portion (not pictured) which fastens to the threaded tip 2 of the fish rod 1. The hook portion 4 of the J-type hook attachment 3 is sized and oriented to allow a user to hook onto a set of wires 6 and retrieve them from locations out of the reach of the user, say behind a wall. The bend portion 7 of the J-type hook attachment 3 is narrow and tapered such that it can push through obstacles and obstructions, but the hook portion 4 protrudes beyond the outer diameter of the fish rod 1 and the body portion 5, exposing it to potentially snagging on objects as the fish rod 1 is retracted with the wires 6 in its hook portion 4. The large opening between the hook portion 4 and the body portion 5 also allows a potential for the set of wires 6 to slip out from the hook portion 4.

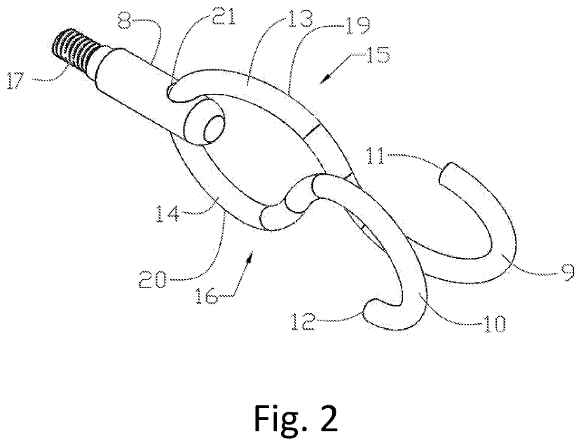

FIG. 2 depicts a device which is an embodiment of the present invention. A threaded post 17 extends from the body portion 8 such that the device may be threadably connected to the threaded tip 2 of a typical fish rod 1. An “S”-shaped first hook member 15 is composed of a first curved section 13 extending laterally to a first furthest point 19 from the body portion 8 and a first hook section 9 which extends laterally in the opposite direction before terminating in a first hook end 11. An “S”-shaped second hook member 16 is composed of a second curved section 14 extending laterally to a second furthest point 20 from the body portion 8 and a second hook section 10 which extends laterally in the opposite direction before terminating in a second hook end 12. The first hook member 15 and second hook member 16 are constructed of a single piece steel and disposed within a hole 21 in the steel body 8 for strength and durability in this embodiment, but a variety of materials or implementations may be employed.

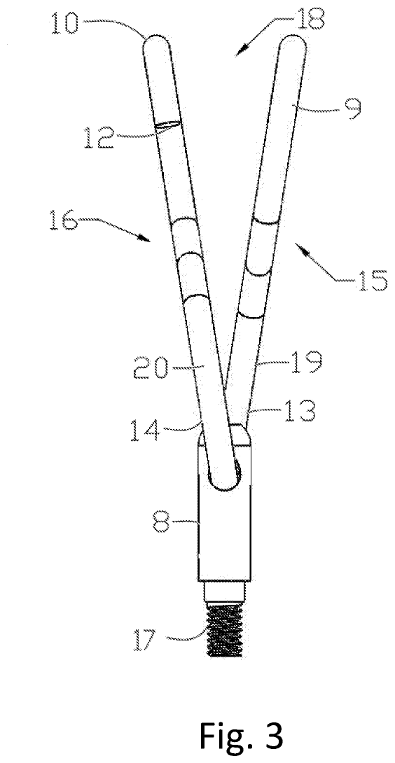

FIG. 3 depicts the device in FIG. 2 viewed from the side and detached from the fish rod 1. In this view, the workpiece gap 18 between the first hook member 15 and the second hook member 16 is apparent. When an elongated workpiece, such as a wire, is inserted into the workpiece gap 18 far enough to clear the first hook end 11 of the first hook member 15, rotation of the device will result in “hooking” the workpiece in the first hook section 9 of the first hook member 15. The second hook member 16 will similarly hook onto any such workpiece with the same motion.

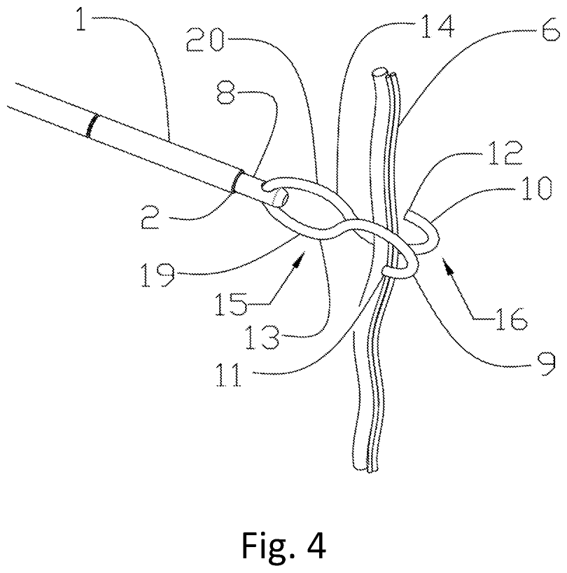

FIG. 4 depicts the device in FIG. 2 affixed to a fish rod 1 in an open position engaging a set of wires 6. A fish rod 1 terminating in a threaded tip 2 is threadedly attached to a body portion 8 of the present invention. A first hook member 15 and a second hook member 16 extend from the body portion 8 such that they may be positioned by the user on opposite sides of a set of wires 6. In this position, the first hook end 11 on the first hook member 15 and the second hook end 12 on the second hook member 16 are positioned beyond and are able to hook onto the set of wires 6.

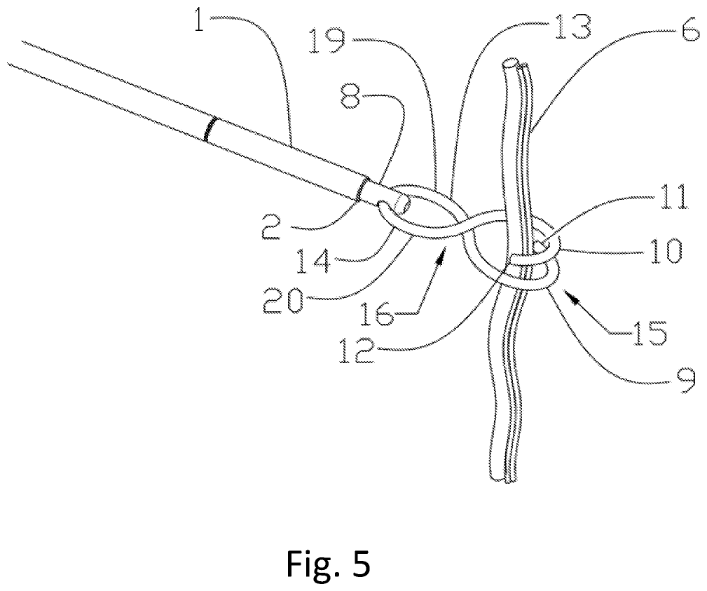

FIG. 5 depicts the device in FIG. 2 in a closed position engaging a set of wires 6, a position attainable from the orientation in FIG. 2 by twisting the fish rod 1 90 degrees clockwise from the user's perspective. In this position, the first hook end 11 on the first hook member 15 and the second hook end 12 on the second hook member 16 are have moved beyond the set of wires 6 are functionally hooked onto the set of wires 6. If the user pulls on the fish rod 1 the first hook section 9 and the second hook section 10 will pull the set of wires 6 towards the user while simultaneously preventing the set of wires 6 from clearing the first hook end 11 and the second hook end 12 and disengaging from the fish rod 1. The first lateral extremity 19 on the first curved section 13 extends laterally beyond the first hook end 11 and the second lateral extremity 20 on the second curved section 14 extends laterally beyond the second hook end 12 to serve as guards, protecting first hook end 11 and second hook end 12 from contact with obstacles when the fish rod 1 is pulled toward the user of the fish rod 1. When the user of the fish rod 1 wishes to disengage the fish rod 1 from the set of wires 6, the user simply twists the fish rod 1 90 degrees counterclockwise, returning the device to the configuration depicted in FIG. 2, such that the set of wires 6 can be retracted from between the first hook end 9 and the second hook end 10.

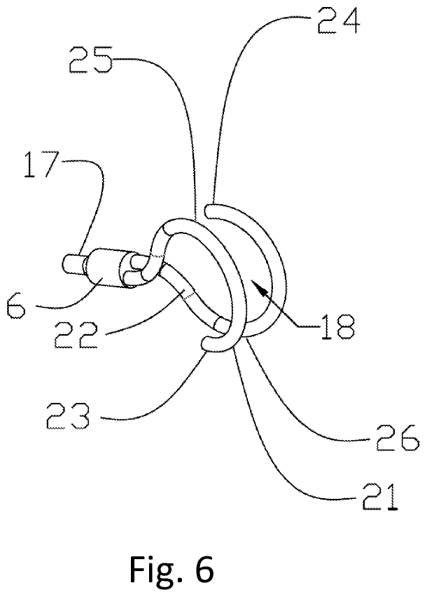

FIG. 6 depicts an alternative embodiment of the present invention. This embodiment features a body 6 with a threaded post 17 such that the device may be threadbly connected to the threaded tip 2 of a fish rod 1. A first C-hook member 21 and a second C-hook member 22 protrude from the body 6, culminating respectively in a first C-hook end 23 and a second C-hook end 24 opposed with to the first C-hook end 23. A workpiece gap 18 is formed between the first C-Hook member 21 and the second C-hook member 22 and is sized to accept a set of wires 6 or other elongated workpiece, and first C-hook end 23 and a second C-hook end 24 may be engaged by twisting the body clockwise and disengaged by twisting the body counterclockwise from the perspective of the user of the fish rod 1. A first C-hook lateral extremity 25 and a second C-hook lateral extremity 26 extend laterally from the body 6 further than their respective first C-hook end 23 an second C-hook end 24 such that they serve to shield the first C-hook end 23 an second C-hook end 24 from obstacles and obstructions when the fish rod 1 is pulled toward its user.

I claim:

1. An engagement member for attachment to a pulling device, the engagement member comprising:
a body;
a first hook member extending laterally from the body and terminating in a first hook end;
a second hook member extending laterally from the body and terminating in a second hook end;
where the first hook end and the second hook end are opposed such that an elongated workpiece may be engaged by rotating the body in a first direction.

2. The engagement member of claim 1, where the first hook member and the second hook member are formed from a single piece of material.

3. The engagement member of claim 2, where the material is steel.

4. The engagement member of claim 1, where the first hook member and the second hook member are shaped in the form of a letter S.

5. The engagement member of claim 1, where the first hook member and the second hook member are shaped in the form of a letter C.

6. The engagement member of claim 1, where a portion of the body is threaded to affix to a pulling device.

7. The engagement member of claim 1, where the elongated workpiece may be disengaged by rotating the body in an opposite second direction.

8. An engagement member for attachment to a pulling device, the engagement member comprising:
a body;
a first hook member extending laterally to a first lateral extremity from the body and terminating in a first hook end;
a second hook member extending laterally from a second lateral extremity form the body and terminating in a second hook end;
where the first lateral extremity extends further from the body than the second hook end and the second lateral extremity extends further from the body than the first hook end.

9. The engagement member of claim 1, where the first hook member and the second hook member are formed from a single piece of material.

10. The engagement member of claim 9, where the material is steel.

11. The engagement member of claim 1, where the first hook member and the second hook member are shaped in the form of a letter S.

12. The engagement member of claim 1, where the first hook member and the second hook member are shaped in the form of a letter C.

13. The engagement member of claim 1, wherein a portion of the body is threaded to affix to a pulling device.
